(19) United States
(12) Patent Application Publication
(10) Pub. No.: US 2014/0232088 A1
(43) Pub. Date: Aug. 21, 2014

(54) COMBINED SHOPPING TROLLEY BABY STROLLER

(71) Applicant: Harri Ektron, Hisings Backa (SE)

(72) Inventor: Harri Ektron, Hisings Backa (SE)

(21) Appl. No.: 14/241,341

(22) PCT Filed: Sep. 17, 2012
(86) PCT No.: PCT/SE2012/000138

§ 371 Date: Feb. 26, 2014

(30) Foreign Application Priority Data
Sep. 15, 2011 (SE) 1100675-6

(51) Int. Cl. B62B 3/02; B62B 7/12

(52) U.S. Cl. CPC B62B 3/027; B62B 7/12
USPC 280/648

(57) ABSTRACT

A folding and combined shopping cart/stroller includes a four-wheeled cross-shaped frame that carries a box-shaped basket and a child seat, thereby creating a functionally designed rigs for manual transportation of goods. The raised platform is positioned above and fixed to the shaft and hang between the front and trailing arms. The basket can be changed to half volume and thus can form a child's seat used in the front of the cart.

This innovation has basically the same appearance as a regular department store shopping cart and stroller depending on condition, yet it has a unique design with unique features and functions. The rig (FIG. 1) is collapsible compact (FIG. 7), and thereto are individually foldable elements. The central portion of the carriage, a shaft (21) which is linked with two pairs of lower profiles called back leg (1) and front leg (2) and carrying the stroller frame, and two pairs of upper profiles called backarms (3) and the arms (4) and coupled to the basket and the handle (12).

Total two pairs are placed in parallel center plates (11) penetrated by the shaft (21) and fixedly mounted on each side of frontlegs (2) upper portion. Each pair of center plates (11) acts as a hinge between the forelegs and hind legs and the front legs and the trailing arm. A locking mechanism (not included in the figures) with the task of keeping frame unfolded is placed at the interface between backarms and backlegs and fastened with both. All four pairs of arms and legs are internally stabilized with either rod. These stabilizing rods (5), (10) the pairs of arms is by example Velcro attached to the basket upper rear and front end, and thus kept the basket on the ground like a hammock. The forward rod (5) is U-shaped to provide child car seat area when the car is half volume formed (FIG. 2) and the screen is then adjusted. Note that all rigid parts may consist of plastic or metal materials etc..

The basket is formed as a rectangular box with no top and the material is made of, for example double layer of fabric connected to said bars on front and rear arms. The canvas is the front and back and the bottom of the basket while the left and right side of the basket consists of elastic textile nets (or other transparent flexible material) to show what's in the basket at the counter in the department store. The fabric and the networks are sewn together and the upper edges of the network are reinforced with strong textile belt (16) which also surrounds the fabric, thus almost around the entire basket to stabilize the car and trailer at the top of the fully erected basket. On the front of the basket are zippers that allow an opening (FIG. 2) that is useful when the basket is half volume position for the user to then be able to add or remove items.

To the basket should have a stable boxform covered the bottom of a pair of rigid discs (eg plastic sheets) embedded in the canvas. One of these rigid boards are positioned in the rear half of the bottom which is tapered from the rear to the front end seen from above, the disks are thus trapezoidformed. The fabric of the bottom of the basket has openings for the discs to be mounted out when necessary.

Basket bottom, front and back (14), (15), instead of cloth and rigid boards composed of interconnected sheets of stiff material, and thereto comprises right and left side of the basket transparent material such networks as in the above case.

The rear of the car includes a collapsible child seat (17), (18) with two large holes in the canvas. This child seat consists of a sitting board linked between a back surface and the basket back as mutually linked with two horizontal swivel arm (13) at the edges and a strap between the arms and the board. Basket their boards and back surface is covered with doth and can be folded compact with a Velcro strap. One or more Velcro is attached to the middle of the basket bottom and surrounds the middle part of the shaft to hold the cage in position relative to the frame. To keep the basket folded like a closed book is a Velcro fastened during basketbottoms rear (19) and front end (19), and these Velcro assembled when basketbottoms halves compressed against each other surfaces. A loose hanging cloth (20) in the form of small basket is attached to the shaft and behind the bar. This is the repository for a back or other goods. A handle (12) is coupled to the ends of the trailing arms.

An accessory (see FIG. 2) to this carriage is a large child seat (22), (23), (24), (25), (26) which is mounted on the front leg cross member. The child seat is made up of three canvascovered discs which are serially connected, a lower seat plate (26), an intermediate plate (24), and an upper seat plate (25). The seat hangs in two pairs of different pins of a rigid material that also holds the seat in place on the frame. The lower pair (23) is rotatably coupled to the front leg cross member with the mounting device and together with the seat bottom plate folded back when the seat is folded and hung to the axis of the upper pair of pins (22). The ends of the lower pair sticks are coupled to lower the seat pan. The upper tine pair (22) the ends of which are fixed to the left and right upper corner of the seat between the plate while the hook-shaped rear ends (22) are shaped to be mounted on the track between the center panels as a console. The pair of sticks is thus stretched horizontally forwardly and holds the lower part of the seat back when the seat is raised, thus worn seat up correctly when the upper seat plate is in line with that extension of the intermediate plate. Between these two plates there is a locking device for fixing. A seat belt mounted on the upper and lower seat plate (not included in the drawings).

Bin and back and front arms described above may be replaced by the following described basket. See FIGS. 8.9 and 10. Note that the rear and front arms can be used with basket model 2.

Basket model 2 described the claims as a dependent (No. 11) but can be independent and have the same purpose and function as a basket in the independent claim (No. 1) and can fold up compactly as a book but has a design that follows;

Basket bottom consists of a front (27) and rear half (28) which is lockable fixable via hinges (29), (30), (with the latch mechanisms) of the basket and the front (31) and rear (32) (with the handle (35)) and these can be rigid sheets or fabric-reinforced rigid frame made of blue metal profiles (33) linking hinges serially. Front and back can thus be fixed without additional arms. Basket rear and front face rotation angle range is folded position pointing upwards in close (they will lean outwards) perpendicular to the respective bottom panels, and can be folded inwards and downwards until they are parallel with the bottom panels. Basketbottoms front half is rotatably coupled with backhalf of basketbottom through the hinge in the middle (34) from that it is in a perpendicular position (latch (36)) against backhalf until both are horizontal and constitute basket bottom. The hinge in the middle holding up the front half when the two halves are in a horizontal position and the same applies backhalf which can also be fixed via the locking mechanism on its underside to either center plates or backlegrod. The hinge in the middle is rotatably coupled via the pipe (37) or (34) to the trailer axle (21) and center plates (11) (in the hole to backarmplate (9)) and is rotatable forwards from the horizontal position until it and bottom halves of adjacent front legs (2). basket left and right side consist of net or other transparent material attached to the car panels edges, this is not shown on the drawings!

### BRIEF DESCRIPTION OF THE DRAWINGS

FIG. 1 shows the perspective from behind of innovation shoppingcart and stroller without front child seat.

FIG. 2 shows the front perspective view of the front child seat and the basket in half volume shape with its front side open.

FIG. 3 shows the perspective view of the front half raised child seat and an enlarged detail A with outer center plate removed to reveal the corresponding parts are interconnected.

FIG. 4 shows an enlarged detail A from FIG. 3. Here is the center plate concealed to reveal how its parts are interconnected!

FIG. 5 shows a side view of the complete customer and stroller with the child seat front collapsed.

FIG. 6 shows a front view with front child seat fully collapsed.

FIG. 7 shows a side view of the cart without little basket folded.

FIG. 8 shows in perspective view and rear view of the basket 2 model without side transparent material.

FIG. 9 shows the side view of the basket 2 model without side transparent material.

FIG. 10 shows the perspective view of the basket model 2 above and from the front side without the transparent material.

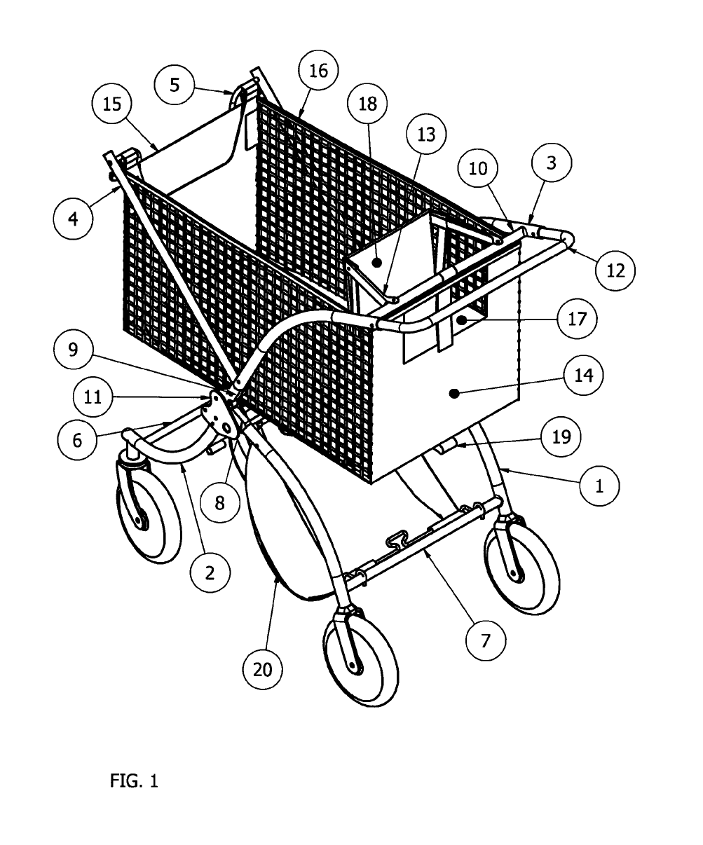

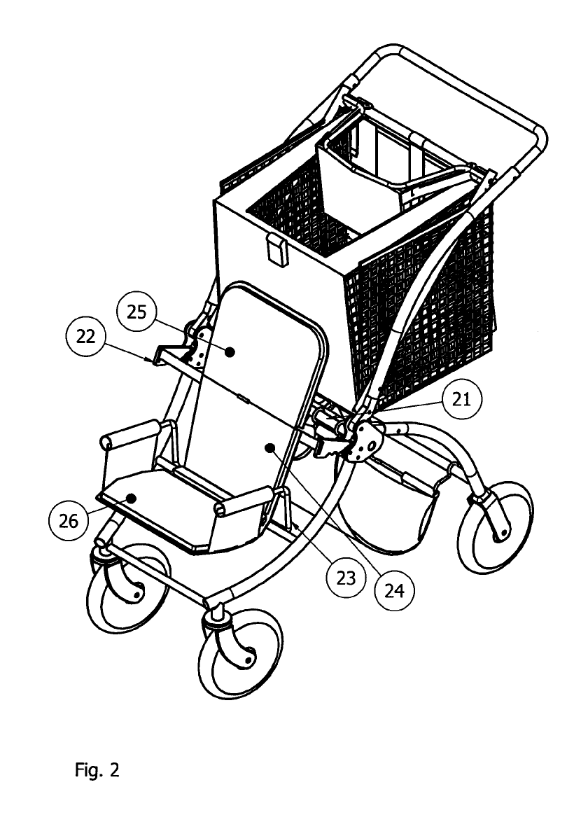

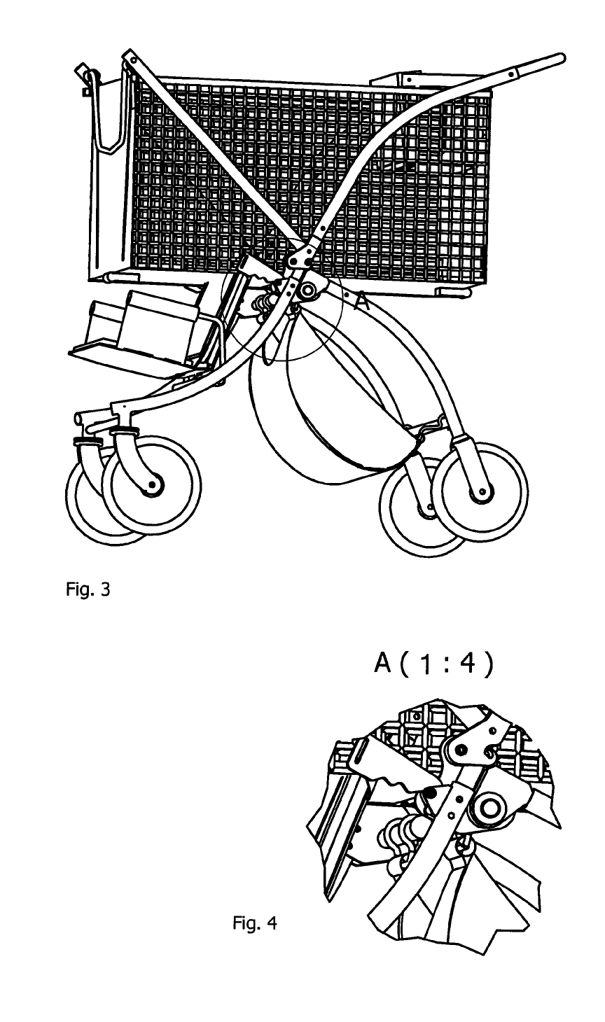

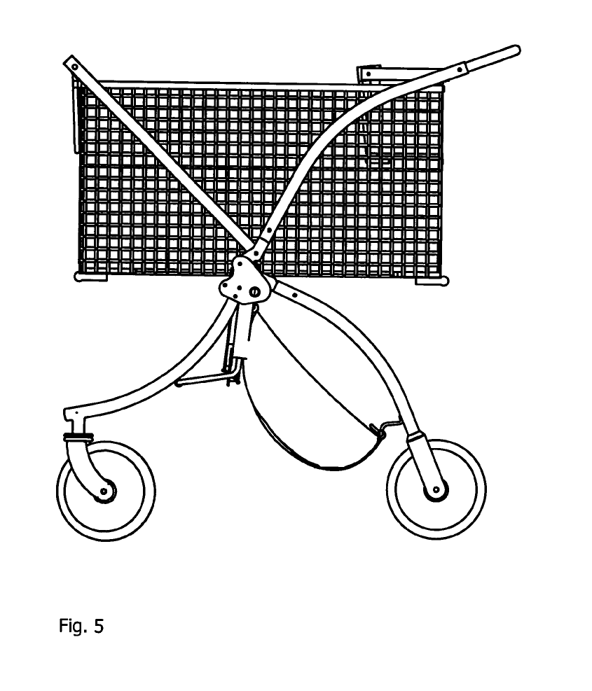

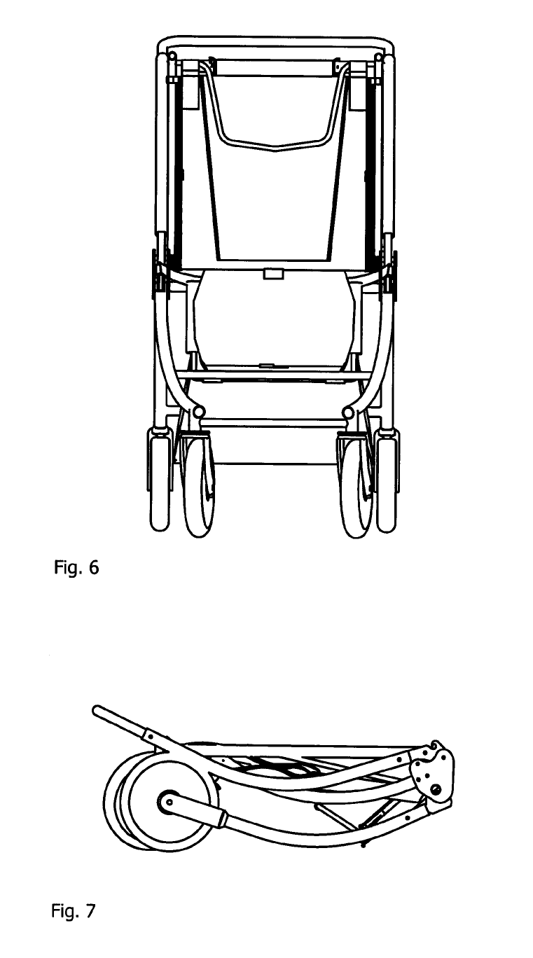

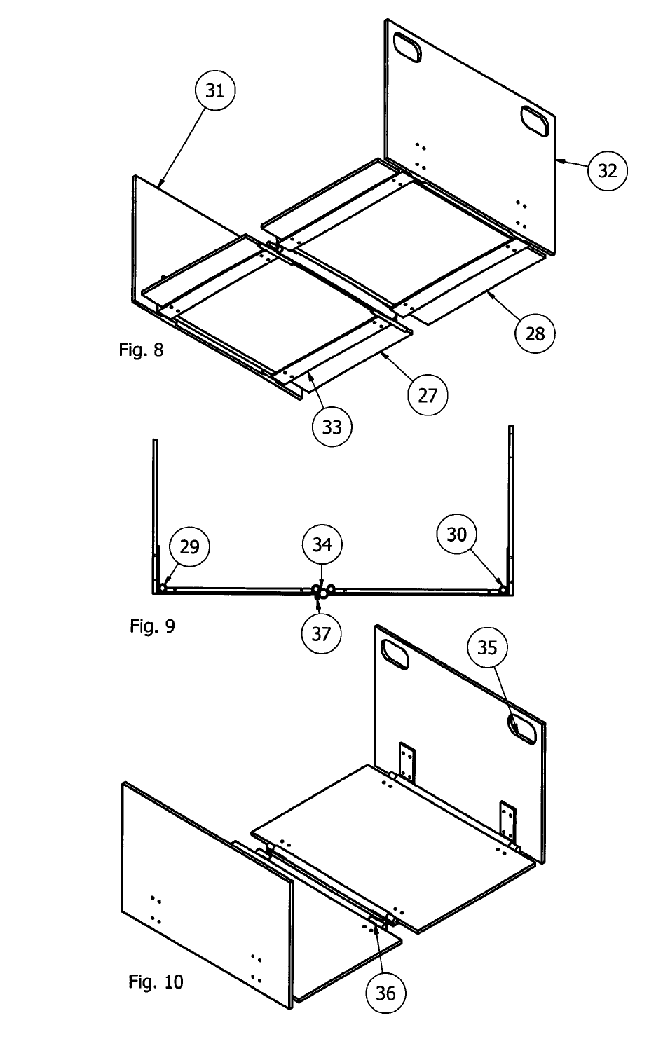

Related fastening elements in the drawings have been omitted to reveal holes.

1. A folding and combined shopping and pram includes a box-shaped collapsible basket, an accessory in the form of a collapsible child seat pivotally attached to a collapsible frame that includes; a pair of front legs (2), which are provided with rotatable wheels on the lower end and the front legs are interconnected by a rod (5).
a pair of legs, which are provided with wheels on the lower end and the legs are interconnected by a rod.
a pair of backarms, connected to a handle and these backarms are interconnected by a rod in the carriage center operates a shaft as the hub linking the respective ends of said limbs forming a cross shaped cross through a center plate fixedly mounted on each side of the leg upper ends. These centers plates thus acts as a hinge linking each said front leg of said rotatable legs until the legs are perpendicular angle position themselves.
a pair of front arms is rotatably connected to the lower portion of said backarms, and a U-shaped rod connecting the arms internally.
a basket of hard bottom and folding hard or soft sides hanging between rear and front arms coupled to the related rods and can be folded like a book or have half the volume as the front arms folded backward.

2. A shopping trolley according to claim 1 includes a box-shaped and collapsible basket made of cloth on its wider back linearly tapered bottom and narrow front side, the fabric is tubular at the rear and front top ends to be coupled to the frame when the screen surrounding said front arm rod with said backarmrod respectively.

3. A shopping trolley according to claim 2, wherein the basket left and right side consist of elastic textile nets or other transparent covering material, with a fixed belt along the edges, which also runs on the outside of the fabric, and forms a circuit for better stability.

4. A shopping trolley according to claim 2 where the basket is kept box shaped by a rigid and
trapezoidformed disc covering the rear half of the basket bottom and a narrower trapezoidformed disc covering the front half of the basket bottom, both panels covered with fabric, but can be removed through openings In the fabric and is flush each other to form a trapezoidformed basket bottom viewed from above.

5. A shopping trolley according to claim 2 where the basket in the line between the said discs being fixed to said shaft (21) by one or more of the sheet attached to velcro strap that surrounds the shaft center portion, thus holding basket shape fixed to the frame center.

6. A shopping trolley according to claims 1, a small folding seat in the rear part of the basket during said backarmrod to accommodate a child or a bag.

7. A shopping cart of claim 1 includes a loosely stretched canvas with rear and front ends that are connected to respective said shaft and behind bars to accommodate a back or other goods.

8. A shopping trolley according to claim 1 wherein said pair of front arms Is angled rearwardly adjacent and parallel to said backarms, which alters the shape of basket to half volume and cubic shape.

9. A shopping trolley according to claim 1 wherein an accessory in the form of child seat includes three serially connected seat disc covered in cloth, of which the lower seat disc is the part which is rotatably mounted on the central portion of the forelimbs by rotating seat sticks that are linked to pages on the lower seat pan.

10. A shopping trolley according to claim 9 wherein the optional child seat Is mounted on said center plate via a hook-shaped end of the upper seat of the pins pointing forwards and fixed to the left and right upper corner of the seat between the plate, which constitutes the bottom portion of the seat back and the seat secured hereby in three dimensions. Seat top plate is aligned with the plate, extending between the plate, fixed by a lock at the unfolding of the seat back portion to be activated.

11. A shopping trolley according to claim 1 wherein said basket, and optionally back and the arms is replaced by another basket as described below;
Basket bottom consists of front and rear half which is lockable fixable via hinges, (with the latch mechanisms) of the basket and the front and rear and may be rigid discs. The basket is reinforced by the rigid frame of for example metal profiles interconnecting hinges serially. Basket rear and front face rotation angle range is folded position pointing upwards in the near right angle with the respective bottom panels, and can be folded inwards and downwards until they are parallel with the bottom panels. Basketbottom front half is rotatably coupled with backhalf of basketbottom through the hinge in the middle from that it is in perpendicular position against backhalf until both are horizontal and constitute basket bottom. The design of the hinge in the middle allowing a fixing of the front half when the two halves are in a horizontal position and the same applies backhalf that can also be fixed via the locking mechanism on either the underside of the center plates or hind leg rod. The hinge in the middle is rotatably coupled to the trailer axle and is rotatable from a horizontal position until it and the bottom halves adjacent to the front legs. Basket right-and left-hand side consists of a network or other transparent material attached to the basket boards edges.
